(19) United States
(12) Patent Application Publication
(10) Pub. No.: US 2013/0098494 A1
(43) Pub. Date: Apr. 25, 2013

(54) RUBBER COMPOSITION FOR WATER HOSE, AND WATER HOSE OBTAINED USING SAME

(71) Applicant: Tokai Rubber Industries, LTD., Komaki-shi (JP)

(72) Inventors: Takashi Yajima, Komaki-shi (JP); Ayumu Ikemoto, Komaki-shi (JP); Ryo Hirai, Komaki-shi (JP)

(73) Assignee: TOKAI RUBBER INDUSTRIES, LTD., Komaki-shi (JP)

(21) Appl. No.: 13/715,460

(22) Filed: Dec. 14, 2012

Related U.S. Application Data
(63) Continuation of application No. PCT/JP2011/071599, filed on Sep. 22, 2011.

(30) Foreign Application Priority Data
Sep. 29, 2010 (JP) 2010-218671

(51) Int. Cl. C08L 19/00; F16L 11/06

(52) U.S. Cl. CPC C08L 19/00; F16L 11/06
USPC 138/118; 525/240; 524/528

(57) ABSTRACT

A rubber composition for a water hose includes the following components (A) and (B), wherein the component (B) has a melt flow rate (MFR) of 1.0 g/10 min at a temperature of 190° C. and a load of 2.16 kg and the component (B) has a density of 0.870 to 0.908 g/cm³: (A) an ethylene-propylene rubber, and (B) an ethylene-octene resin.

### BACKGROUND OF THE INVENTION

1. Technical Field

The present disclosure relates to a rubber composition for a water hose and a water hose obtained using the same. The water hose is, for example, used as a radiator hose which is used for connecting an engine and a radiator in vehicles such as automobiles.

2. Related Art

Until now, the main components of a rubber composition for a radiator hose for vehicles, which is used for connecting an engine and a radiator, have been ethylene-propylene-diene terpolymer rubber (EPDM) and the like. An inorganic filler such as silica or calcium carbonate is mixed with the rubber.

In recent years, improvement of fuel economy by reducing the weight of car parts like a radiator hose is demanded as measures to prevent global warming. Accordingly, for a 20% weight reduction of a radiator hose, the techniques such as the following (1) and (2) are considered:

(1) a reduction in the specific gravity of a rubber mixture, and
(2) a reduction in the wall thickness of a hose from conventional 5.0 mm to 3.5 mm.

A rubber hose material has been proposed for achieving the above (1) reduction in the specific gravity of a rubber mixture (JP 2005-106185 A). In the rubber hose material, an ethylene-olefin resin (an organic filler) is used in place of an inorganic filler such as silica or calcium carbonate.

### SUMMARY OF THE INVENTION

A rubber composition for a water hose includes the following components (A) and (B), wherein the component (B) has a melt flow rate (MFR) of 1.0 g/10 min at a temperature of 190° C. and a load of 2.16 kg and the component (B) has a density of 0.870 to 0.908 g/cm³:

(A) an ethylene-propylene rubber, and
(B) an ethylene-octene resin.

### BRIEF DESCRIPTION OF DRAWINGS

FIG. 1 is a schematic diagram illustrating the occurrence state of thickness deviation (wrinkles and bumps) in a thin-walled hose.

### DETAILED DESCRIPTION OF THE INVENTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

By using the rubber hose material described in JP 2005-106185 A, the above (1) reduction in the specific gravity of a rubber mixture can be achieved. Further, the weight of a radiator hose can be reduced. For attempting a further weight reduction, it is preferred that the technique described in this publication and the technique of the above (2) reduction in the wall thickness of a hose be combined. In the production of a radiator hose, an unvulcanized hose is generally produced by extrusion molding of a rubber hose material. After that, the unvulcanized hose is formed into a desired bent shape, and thus a radiator hose is obtained. For example, a mandrel in the predetermined shape of a bent tube is prepared. The above unvulcanized hose is inserted into the mandrel, and the unvulcanized hose is then vulcanized, followed by drawing out the mandrel. Thus, a radiator hose in the desired bent shape is obtained.

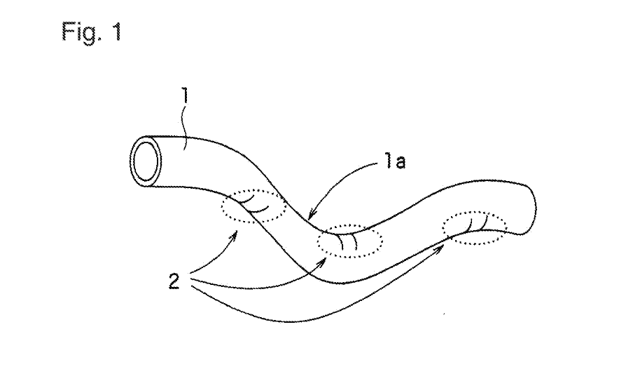

The hose (about 3.5 mm thick) is, however, thinner than a conventional thick hose (about 5.0 mm thick). Thus, as shown in FIG. 1, the inside of the bending part 1a of the hose 1 is easily pressed. Therefore, thickness deviation (wrinkles and bumps) 2 easily occurs in the bending part 1a of the hose 1. Accordingly, there has been room for improvement in inhibition of the occurrence of the thickness deviation (wrinkles and bumps) 2 in the hose.

A rubber composition is provided for a water hose which is capable of producing a thin-walled and light-weight hose in which thickness deviation (wrinkles and bumps) is less prone to occur, and a water hose obtained using the same.

The rubber composition for a water hose according to a first aspect of the present disclosure includes the following components (A) and (B). The component (B) has a melt flow rate (MFR) of 1.0 g/10 min at a temperature of 190° C. and a load of 2.16 kg. Further, the component (B) has a density of 0.870 to 0.908 g/cm³:

(A) an ethylene-propylene rubber, and
(B) an ethylene-octene resin.

Further, the water hose according to a second aspect of the present disclosure is a water hose in a bent shape obtained by forming an unvulcanized hose using the rubber composition for a water hose according to claim 1 and vulcanizing the unvulcanized hose which is inserted into a mandrel in the shape of a bending tube.

That is, as a result of repeated investigations on a rubber material in JP 2005-106185 A, the present inventors found that the cause of the thickness deviation (wrinkles and bumps) that easily occurs at insertion into a mandrel is the insufficient strength of an unvulcanized hose. Thus, the present inventors focused on especially an ethylene-octene resin among ethylene-olefin resins used as organic fillers. For the most part, the present inventors repeatedly studied the melt flow rate (MFR) and the density of the ethylene-octene resin. The present inventors found that as the melt flow rate (MFR), an index of molecular weight, increased, the molecular weight increased, and consequently the strength of unvulcanized rubber was improved. The present inventors further found that as the density, an index of branching of molecular chains, increased, the branching of molecular chains decreased, and consequently the mixing properties of the ethylene-octene resin with an ethylene-propylene rubber were improved.

As a result of repeated experiments on the optimum melt flow rate (MFR) and the optimum density of the ethylene-octene resin, the present inventors found that the intended object could be achieved by using an ethylene-octene resin with a melt flow rate (MFR) of 1.0 g/10 min at a temperature of 190° C. and a load of 2.16 kg and a density of 0.870 to 0.908 g/cm³.

Although the reasons are not clear, the following point is conjectured as a reason. That is, when using an ethylene-octene resin with specific ranges of melt flow rates (MFR) and densities, side chains of the ethylene-octene resin are easily intertwined with an ethylene-propylene rubber. Consequently, green strength is improved. Thus, the occurrence of thickness deviation (wrinkles and bumps) in an unvulcanized hose at insertion into a mandrel can be inhibited.

As described above, in the production of the rubber composition for a water hose of the present disclosure, an ethylene-octene resin (Component B) with predetermined melt flow rate (MFR) and density is used as an organic filler (an ethylene-olefin resin). Thus, a thin-walled and light-weight water hose in which thickness deviation (wrinkles and bumps) is less prone to occur can be obtained.

The content of the above ethylene-octene resin (Component B) may be 8 to 20 parts by weight per 100 parts by weight of the above ethylene-propylene rubber (Component A). In this case, green strength is improved according to the degree of entanglement of the ethylene-octene resin and the ethylene-propylene rubber (Component A). The mixing properties of the ethylene-octene resin with the ethylene-propylene rubber (Component A) are also good.

The rubber composition for a water hose of the present disclosure can contain both silica and a silane coupling agent. In this case, e.g. corrosion of a pipe material (a fastening part of an aluminum pipe) can be prevented. The water hose of the present disclosure is formed by using the above special rubber composition for a water hose. Thus, the water hose has a nearly uniform thickness of 3.5 mm or less. Thus, the water hose is lightweight. Further, thickness deviation (wrinkles and bumps) is less prone to occur in a bending part of the hose.

The embodiment of the present disclosure will be now described in detail. It should be noted, however, that the present disclosure is not limited to the embodiment.

The rubber composition for a water hose of the present disclosure (hereinafter may be simply referred to as “rubber composition”) can be obtained by using an ethylene-propylene rubber (Component A) and an ethylene-octene resin (Component B). The above ethylene-octene resin (Component B) has a melt flow rate (MFR) of 1.0 g/10 min at a temperature of 190° C. and a load of 2.16 kg. In addition, the above ethylene-octene resin has a density of 0.870 to 0.908 g/cm³. This may be the largest feature of the present disclosure. These components will now be described.

<<Ethylene-Propylene Rubber (Component A)>>

Examples of the above ethylene-propylene rubber (Component A) include ethylene-propylene-diene terpolymer rubber (EPDM) and ethylene-propylene copolymer rubber (EPM). These are used individually or two or more are used in combination.

The above ethylene-propylene rubber (Component A) preferably has an iodine value of 6 to 30 and an ethylene ratio of 48 to 70% by weight in terms of excellent stability under high temperature and high pressure. The ethylene-propylene rubber (Component A) particularly preferably has an iodine value of 10 to 24 and an ethylene ratio of 50 to 60% by weight.

It is preferred that a diene monomer (the third component) contained in the above EPDM be a diene monomer having 5 to 20 carbon atoms. Specific examples of the diene monomers include e.g. 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene (DCP), 5-ethylidene-2-norbornene (ENB), 5-butylidene-2-norbornene , 2-methallyl-5-norbornene and 2-isopropenyl-5-norbornene. It is preferred that the diene monomer (the third component) be dicyclopentadiene (DCP) or 5-ethylidene-2-norbornene (ENB).

<<Ethylene-Octene Resin (Component B)>>

Next, the ethylene-octene resin (Component B) used in conjunction with the above ethylene-propylene rubber (Component A) includes resins in which ethylene and octene-1 are copolymerized; and the like.

The above ethylene-octene resin (Component B) has a melt flow rate (MFR) of 1.0 g/10 min (190° C., 2.16 kg load). That is, when MFR of Component B is too low, molecular weight is too low and thus green strength is inferior. Thus, thickness deviation (wrinkles and bumps) easily occurs at insertion into a mandrel. On the contrary, when MFR of Component B is too high, molecular weight is too high and thus green strength is too high. Thus, the insertion properties of an unvulcanized hose into a mandrel are worsened.

As used herein, the “melt flow rate (MFR)” means the melt flow rate (MFR) at a temperature of 190° C. and a load of 2.16 kg unless otherwise specified. The melt flow rate (MFR) is synonymous with melt index.

Additionally, the above ethylene-octene resin (Component B) has a density of 0.870 to 0.908 g/cm³. That is, when the density of Component B is too low, branching of molecular chains increases. Thus, compatibility between the ethylene-octene resin (Component B) and the ethylene-propylene rubber (Component A) is worsened. On the contrary, when the density of Component B is too high, branching of molecular chains decreases. Thus, the effect of entanglement of the ethylene-octene resin (Component B) and the ethylene-propylene rubber (Component A) is small. Thus, green strength is insufficient. Consequently, thickness deviation (wrinkles and bumps) occurs in an unvulcanized hose at insertion into a mandrel.

The content of the above ethylene-octene resin (Component B) is preferably 8 to 20 parts by weight and particularly preferably 9 to 15 parts by weight per 100 parts by weight of the ethylene-propylene rubber (Component A). That is, when the content of Component B is too low, the effect of improving green strength according to the degree of entanglement of the ethylene-octene resin (Component B) and the ethylene-propylene rubber (Component A) tends to be small. On the contrary, when the content of Component B is too high, processability of a rubber composition for a water hose tends to be worsened.

In addition to the above ethylene-propylene rubber (Component A) and the above ethylene-octene resin (Component B), as appropriate, e.g. silica, a silane coupling agent, carbon black, a vulcanizing agent, a vulcanization accelerator, a vulcanizing activator, a process oil, a co-crosslinking agent and an antioxidant can be suitably mixed with the rubber composition of the present disclosure. These are used individually or two or more are used in combination. In the present embodiment, it is preferred that silica and a silane coupling agent be used in combination to inhibit e.g. corrosion of a pipe material (a fastening part of an aluminum pipe).

<<Silica>>

The content of the above silica is preferably 5 to 60 parts by weight and particularly preferably 10 to 40 parts by weight per 100 parts by weight of the ethylene-propylene rubber (Component A). When the content of silica is too low, specific volume resistivity tends to be difficult to increase. When the content of silica is too high, the processability of a rubber composition for a water hose tends to be worsened.

<<Silane Coupling Agent>>

The content of the above silane coupling agent is preferably 0.1 to 10 parts by weight and particularly preferably 0.5 to 5 parts by weight per 100 parts by weight of the ethylene-propylene rubber (Component A). When the content of a silane coupling agent is too low, the breaking strength of rubber tends to be lowered. When the content of a silane coupling agent is too high, the elongation of rubber tends to decrease.

<<Carbon Black>>

It is preferred that the above carbon black be excellent in extrusion processability and reinforcement. Examples of this type of carbon black include carbon black of SAF, ISAF, HAF, MAF, FEF, GPF, SRF, FT and MT. These are used individually or two or more are used in combination. The content of the above carbon black is preferably 20 to 140 parts by weight and particularly preferably 60 to 130 parts by weight per 100 parts by weight of the ethylene-propylene rubber (Component A). That is, when the content of carbon black is too low, the effect of reinforcement depending on it is insufficient. Thus, the hardness of a rubber composition for a water hose tends to be difficult to increase. On the contrary, when the content of carbon black is too high, the specific volume resistivity of a rubber composition for a water hose decreases. Consequently, the electrical resistance properties of the rubber composition for a water hose tend to be worsened.

<<Vulcanizing Agent>>

Examples of the above vulcanizing agents include sulfur and peroxide crosslinking agents (peroxide vulcanizing agents). These are used individually or used in combination. It is preferred that the vulcanizing agent be sulfur in terms of storage stability and costs.

Examples of the above peroxide crosslinking agents include peroxy ketals, dialkyl peroxides, diacyl peroxides, peroxyesters and hydroperoxides. The peroxy ketals include e.g. 1,1-bis(t-butylperoxy)-3,3,5-trimethylcyclohexane, 1,1-bis(t-hexylperoxy)-3,3,5-trimethylcyclohexane, 1,1-bis(t-hexylperoxy)cyclohexane, 1,1-bis(t-butylperoxy)cyclododecane, 1,1-bis(t-butylperoxy)cyclohexane, 2,2-bis(t-butylperoxy)octane, n-butyl-4,4-bis(t-butylperoxy)butane and n-butyl-4,4-bis(t-butylperoxy)valerate. The dialkyl peroxides include e.g. di-t-butylperoxide, dicumyl peroxide, t-butylcumyl peroxide, α,α′-bis(t-butylperoxy-m-isopropyl)benzene, α,α′-bis(t-butylperoxy)diisopropylbenzene, 2,5-dimethyl-2,5-di(t-butylperoxy)hexane and 2,5-dimethyl-2,5-bis(t-butylperoxy)hexine-3. The diacyl peroxides include e.g. acetyl peroxide, isobutyryl peroxide, octanoyl peroxide, decanoyl peroxide, lauroyl peroxide, 3,5,5-trimethyl hexanoyl peroxide, benzoyl peroxide, 2,4-dichlorobenzoyl peroxide and m-trioyl peroxide. The peroxyesters include e.g. t-butylperoxyacetate, t-butylperoxyisobutyrate, t-butylperoxy-2-ethylhexanoate, t-butylperoxy laurate, t-butylperoxy benzoate, di-t-butylperoxy isophthalate, 2,5-dimethyl-2,5-di(benzoylperoxy)hexane, t-butyl peroxymaleic acid, t-butyl peroxyisopropylcarbonate and cumyl peroxyoctate. The hydroperoxides include e.g. t-butyl hydroperoxide, cumen hydroperoxide, diisopropylbenzene hydroperoxide, 2,5-dimethylhexane-2,5-dihydroperoxide and 1,1,3,3-tetramethylbutylperoxide. These are used individually or two or more are used in combination. Among these, 2,5-dimethyl-2,5-di(t-butylperoxy)hexane is suitably used in terms of no odor problems.

When sulfur is used as the above vulcanizing agent, the content thereof is preferably 0.3 to 15.0 parts by weight and particularly preferably 0.5 to 1.5 parts by weight per 100 parts by weight of the ethylene-propylene rubber (Component A).

When a peroxide crosslinking agent is used as the above vulcanizing agent, the content thereof is preferably 1.5 to 20.0 parts by weight and particularly preferably 5 to 10 parts by weight per 100 parts by weight of the ethylene-propylene rubber (Component A). That is, when the content of a vulcanizing agent is too low, vulcanization is inadequate and thus the strength of a hose tends to be weakened. On the contrary, when the content of a vulcanizing agent is too high, a hose is too hard and thus the flexibility of the hose tends to be worsened. Further, scorch time becomes shorter and thus the processability of a rubber composition for a water hose tends to be worsened.

<<Vulcanization Accelerator>>

Examples of the above vulcanization accelerators include vulcanization accelerators of e.g. thiazoles, sulfenamides, thiurams, aldehyde ammonias, aldehyde amines, guanidines and thioureas. These are used individually or two or more are used in combination. Among these, sulfenamide vulcanization accelerators are preferred in terms of excellent vulcanization reactivity.

The content of the above vulcanization accelerator is preferably 0.1 to 10 parts by weight and particularly preferably 0.5 to 6.0 parts by weight per 100 parts by weight of the ethylene-propylene rubber (Component A). Examples of the above thiazole vulcanization accelerators include dibenzothiazyl disulfide (DM), 2-mercapto benzothiazole (M), 2-mercapto benzothiazole sodium salt (NaMBT) and 2-mercapto benzothiazole zinc salt (ZnMBT). These are used individually or two or more are used in combination. Among these, dibenzothiazyl disulfide (DM) or 2-mercapto benzothiazole (M) is preferred in terms of excellent vulcanization reactivity.

Examples of the above sulfenamide vulcanization accelerators include N-oxydiethylene-2-benzothiazolyl sulfenamide (NOBS), N-cyclohexyl-2-benzothiazolyl sulfenamide (CM), N-t-butyl-2-benzothiazoyl sulfenamide (BBS) and N,N′-dicyclohexyl-2-benzothiazoyl sulfenamide. These are used individually or two or more are used in combination.

Examples of the above thiuram vulcanization accelerators include tetramethylthiuram disulfide (TT), tetraethylthiuram disulfide (TET), tetrabutylthiuram disulfide (TBTD), tetrakis(2-ethylhexyl)thiuram disulfide (TOT) and tetrabenzylthiuram disulfide (TBZTD). These are used individually or two or more are used in combination.

<<Vulcanizing Activator>>

Examples of the above vulcanizing activators include zinc white (ZnO), stearic acid and magnesium oxide. These are used individually or two or more are used in combination. The content of the above vulcanizing activator is preferably 1 to 25 parts by weight and particularly preferably 3 to 10 parts by weight per 100 parts by weight of the above ethylene-propylene rubber (Component A).

<<Process Oil>>

Examples of the above process oils include naphthene oils, paraffin oils and aroma oils. These are used individually or two or more are used in combination. The content of the above process oil is preferably 5 to 100 parts by weight and particularly preferably 20 to 80 parts by weight per 100 parts by weight of the ethylene-propylene rubber (Component A).

<<Co-Crosslinking Agent>>

As the above co-crosslinking agents, for example, divinylbenzene and triallyl isocyanurate (TAIC) are suitably used. In addition to these compounds, the above co-crosslinking agents include triallyl cyanurate, diacetone diacrylamide, polyethylene glycol diacrylate, polyethylene glycol dimethacrylate, trimethylolpropane trimethacrylate, trimethylolpropane triacrylate, ethylene glycol dimethacrylate, triethylene glycol dimethacrylate, diethylene glycol dimethacrylate, diisopropenylbenzene, p-quinone dioxime, p,p-dibenzoyl quinone dioxime, phenylmaleimide, allylmethacrylate, N,N-m-phenylene bismaleimide, diallylphthalate, tetraallyloxyethane and 1,2-polybutadiene. These are used individually or two or more are used in combination.

The content of the above co-crosslinking agent is preferably 0.1 to 10.0 parts by weight and particularly preferably 0.5 to 7.0 parts by weight per 100 parts by weight of the ethylene-propylene rubber (Component A).

<<Antioxidant>>

Examples of the above antioxidants include antioxidants and waxes. The antioxidants include carbamates, phenylenediamines, phenols, diphenylamines, quinolines and the like. These are used individually or two or more are used in combination.

The content of the above antioxidant is preferably 0.2 to 2.0 parts by weight and particularly preferably 0.5 to 1.0 parts by weight per 100 parts by weight of the ethylene-propylene rubber (Component A).

The rubber composition of the present disclosure, for example, can be prepared as follows. That is, the ethylene-octene resin (Component B) as an organic filler is mixed with the ethylene-propylene rubber (Component A). Further as appropriate, carbon black, a vulcanizing agent, a process oil, a vulcanization accelerator and the like are mixed with the ethylene-propylene rubber (Component A). These are kneaded using a kneading machine such as a kneader, Banbury mixer or a roller.

The specific volume resistivity of the rubber composition of the present disclosure is preferably 1×10⁶ Ω·cm or more and particularly preferably 1×10⁸ Ω·cm or more in terms of e.g. corrosion prevention of a pipe. Additionally, the above specific volume resistivity can be measured in accordance with JIS K 6271.

The water hose of the present disclosure can be produced using the rubber composition prepared as above e.g. in a manner such as the following.

That is, the rubber hose composition prepared as above is extruded to produce an unvulcanized hose. In addition, an unvulcanized hose can be produced by extruding a rubber composition into a mandrel in a straight shape.

Next, a mandrel in the predetermined shape of a bending tube is prepared. The above unvulcanized hose is inserted into the mandrel by e.g. an inserting machine or fingers of workers. After that, the unvulcanized hose is vulcanized under predetermined conditions (140 to 160° C.×30 to 60 min). The mandrel is then drawn out. Thus, a water hose in a desired bent shape can be produced.

The water hose of the present disclosure thus obtained generally has an inside diameter of 5 to 50 mm and an uniform thickness of 3.5 mm or less. Further, there is hardly any thickness deviation (wrinkles and bumps) in a bending part of the water hose. The water hose of the present disclosure is thinner than a conventional thick hose (about 5.0 mm thick). The thickness of the water hose is preferably 1.5 to 3.5 mm.

### EXAMPLES

Examples will be now described along with Comparative Examples. It should be noted, however, that the present disclosure is not limited to these Examples.

First, the materials described below were prepared to make examples and comparative examples.

[EPDM (Component A)]

ESPRENE 501A manufactured by Sumitomo Chemical Co., Ltd.

[EPM (Component A)]

ESPRENE 201 manufactured by Sumitomo Chemical Co., Ltd.

[Ethylene-octene resin (Component B)]

<Ethylene-octene resin (B1)>

ENGAGE 8480 manufactured by The Dow Chemical Company [melt flow index (MFR) 1.0 g/10 min, density 0.902 g/cm³]

<Ethylene-octene resin (B2)>

ENGAGE 8110 manufactured by The Dow Chemical Company [melt flow index (MFR) 1.0 g/10 min, density 0.870 g/cm³]

<Ethylene-octene resin (B3)>

ENGAGE 8540 manufactured by The Dow Chemical Company [melt flow index (MFR) 1.0 g/10 min, density 0.908 g/cm³]

[Ethylene-octene resin (for Comparative Examples)]

<Ethylene-octene resin (B′1)>

ENGAGE 8402 manufactured by The Dow Chemical Company [melt flow index (MFR) 30.0 g/10 min, density 0.902 g/cm³]

<Ethylene-octene resin (B′2)>

ENGAGE 8180 manufactured by The Dow Chemical Company [melt flow index (MFR) 0.5 g/10 min, density 0.863 g/cm³]

<Ethylene-octene resin (B′3)>

ENGAGE 8842 manufactured by The Dow Chemical Company [melt flow index (MFR) 1.0 g/10 min, density 0.857 g/cm³]

<Ethylene-octene resin (B′4)>

EXACT 0230 manufactured by DEXPLASTOMERS [melt flow index (MFR) 30.0 g/10 min, density 0.902 g/cm³]

[Processing Aid]

Stearic acid (beads, stearic acid Sakura manufactured by NOF CORPORATION)

[Zinc Oxide]

Two zinc oxides manufactured by MITSUI MINING & SMELTING CO., LTD.

[Carbon Black]

SRF carbon black (SHOBLACK IP-200 manufactured by Showa Cabot Corp.)

[Silica]

Silica (Nipsil ER manufactured by TOSOH SILICA CORPORATION)

[Silane Coupling Agent]

3-Mercaptopropyl-trimethoxysilane (50% soft granule) (Silanogran M manufactured by Kettlitz-Chemie GmbH & Co. KG)

[Peroxide Crosslinking Agent]

2,5-Dimethyl-2,5-di(t-butylperoxy)hexane (PERHEXA 25B-40 manufactured by NOF CORPORATION)

[Co-Crosslinking Agent]

Ethylene glycol dimethacrylate (Hi-Cross ED manufactured by Seiko Chemical Co., Ltd.)

[Antioxidant]

2,2,4-Trimethyl-1,2-dihydroquinoline (TMDQ) (NONFLEX RD manufactured by Seiko Chemical Co., Ltd.)

[Process Oil]

Paraffin oil (Sunflex 2280 manufactured by JAPAN SUN OIL COMPANY, LTD.)

[Vulcanization Accelerator (i)]

Sanceler TT-G manufactured by SANSHIN CHEMICAL INDUSTRY CO., LTD.

[Vulcanization Accelerator (ii)]

Sanceler TET-G manufactured by SANSHIN CHEMICAL INDUSTRY CO., LTD.

[Vulcanization Accelerator (iii)]

Sanceler CM manufactured by SANSHIN CHEMICAL INDUSTRY CO., LTD.

[Vulcanization Accelerator (iv)]

Sanceler DM manufactured by SANSHIN CHEMICAL INDUSTRY CO., LTD.

[Vulcanizing Agent (Sulfur)]

Sulfur PTC manufactured by Daito Sangyo Co., Ltd.

### Examples 1 to 7

### Comparative Examples 1 to 4

Each component shown in Tables 1 and 2 shown below was mixed in a proportion shown in the tables. The mixture was kneaded using Banbury mixer and a roller to prepare a rubber composition.

Using rubber compositions of Examples and Comparative Examples thus obtained, various characteristics were evaluated in accordance with standards described below. These results are shown in Tables 1 and 2 shown below.

[Initial Properties]

Each rubber composition was press-vulcanized at 150° C. for 30 minutes. Thus, a vulcanized rubber sheet with a thickness of 2 mm was produced. After that, the vulcanized rubber sheet was punched out by a JIS No. 5 dumbbell to obtain a sample. Tensile strength (TB) and elongation (EB) of the sample were evaluated in accordance with JIS K 6251.

[Specific Gravity]

The specific gravity of each rubber composition was measured in accordance with JIS K 6220. The rubber composition with a specific gravity of 1.16 or less can be evaluated as low specific gravity. By using the rubber composition with low specific gravity, the weight of a radiator hose can be reduced.

[Green Strength]

Each rubber composition was pressed at 100° C. for 5 minutes to produce an unvulcanized rubber sheet with a thickness of 2 mm. After that, the unvulcanized rubber sheet was punched out by a JIS No. 1 dumbbell to obtain a sample. The yield point stress of the sample was measured using a strograph under an atmosphere of 25° C. and 60° C. The yield point stress was considered as green strength.

In the case where a rubber composition has a green strength of 0.5 MPa (the target value) or more, thickness deviation (wrinkles and bumps) is less prone to occur when the rubber composition is inserted into a mandrel. That is, in this case, the insertion properties of the rubber composition into a mandrel are good. On the contrary, in the case where a rubber composition has a green strength of below 0.5 MPa (the target value), thickness deviation (wrinkles and bumps) easily occurs when the rubber composition is inserted into a mandrel. That is, in this case, the insertion properties of the rubber composition into a mandrel is bad. Additionally, the operation of inserting an ordinary rubber composition into a mandrel is carried out under an atmosphere of 60° C. Thus, green strength was measured at room temperature (25° C.) and 60° C. and evaluated.

[Specific Volume Resistivity]

The specific volume resistivity of each rubber composition was measured in accordance with JIS K 6271.

[Extrusion Processability]

Each rubber composition was extruded and extrusion processability was evaluated. The evaluation was carried out by deciding the quality of extrusion textures by visual inspection. Rubber compositions decided to be good were given ◯, while the other cases were given x.

TABLE 1
(parts by weight)

| | | Examples | | | | | | |
|---|---|---|---|---|---|---|---|---|
| | | 1 | 2 | 3 | 4 | 5 | 6 | 7 |
| EPDM | | 100 | 100 | 100 | — | 100 | 100 | 100 |
| EPM | | — | — | — | 100 | — | — | — |
| Stearic acid | | 1 | 1 | 1 | 1 | 1 | 1 | 1 |
| Zinc oxide | | 5 | 5 | 5 | 5 | 5 | 5 | 5 |
| Ethylene-octene resin | | 10 | 8 | 20 | 10 | 10 | 10 | 10 |
| (Type) | | B1 | B1 | B1 | B1 | B2 | B3 | B1 |
| MFR (g/10 min) | | 1.0 | 1.0 | 1.0 | 1.0 | 1.0 | 1.0 | 1.0 |
| Density (g/cm³) | | 0.902 | 0.902 | 0.902 | 0.902 | 0.870 | 0.908 | 0.902 |
| Carbon black | | 130 | 130 | 130 | 130 | 130 | 130 | 80 |
| Silica | | — | — | — | — | — | — | 20 |
| Silane coupling agent | | — | — | — | — | — | — | 1 |
| Peroxide crosslinking agent | | — | — | — | 5 | — | — | — |
| Co-crosslinking agent | | — | — | — | 3 | — | — | — |
| Antioxidant | | — | — | — | 0.5 | — | — | — |
| Process oil | | 63 | 63 | 63 | 63 | 63 | 63 | 63 |
| Vulcanization accelerator (i) | | 1 | 1 | 1 | — | 1 | 1 | 1 |
| Vulcanization accelerator (ii) | | 1 | 1 | 1 | — | 1 | 1 | 1 |
| Vulcanization accelerator (iii) | | 1 | 1 | 1 | — | 1 | 1 | 1 |
| Vulcanization accelerator (iv) | | 1 | 1 | 1 | — | 1 | 1 | 1 |
| Vulcanizing agent (sulfur) | | 1 | 1 | 1 | — | 1 | 1 | 1 |
| Initial properties | TB(MPa) | 11.4 | 11.0 | 11.0 | 15.0 | 11.4 | 11.4 | 14.5 |
| | EB (%) | 560 | 550 | 620 | 370 | 560 | 560 | 620 |
| Specific gravity | | 1.153 | 1.154 | 1.140 | 1.153 | 1.153 | 1.153 | 1.100 |
| Green strength | 25° C. (MPa) | 1.52 | 1.40 | 2.15 | 1.52 | 1.50 | 1.45 | 2.00 |
| | 60° C. (MPa) | 0.60 | 0.55 | 1.14 | 0.60 | 0.58 | 0.58 | 0.60 |

| | | | | | | | |
|---|---|---|---|---|---|---|---|
| Specific volume resistivity | 5 × 10⁵ | 5 × 10⁵ | 9 × 10⁵ | 1 × 10⁶ | 3 × 10⁵ | 4 × 10⁵ | 4 × 10⁸ |
| (Ω·cm) | | | | | | | |
| Extrusion processability | ◯ | ◯ | ◯ | ◯ | ◯ | ◯ | ◯ |

TABLE 2
(parts by weight)

| | | Comparative Examples | | | |
|---|---|---|---|---|---|
| | | 1 | 2 | 3 | 4 |
| EPDM | | 100 | 100 | 100 | 100 |
| EPM | | — | — | — | — |
| Stearic acid | | 1 | 1 | 1 | 1 |
| Zinc oxide | | 5 | 5 | 5 | 5 |
| Ethylene-octene resin | | 10 | 10 | 10 | 10 |
| (Type) | | B′1 | B′2 | B′3 | B′4 |
| MFR (g/10 min) | | 30.0 | 0.5 | 1.0 | 30.0 |
| Density (g/cm³) | | 0.902 | 0.863 | 0.857 | 0.902 |
| Carbon black | | 130 | 130 | 130 | 130 |
| Peroxide crosslinking agent | | — | — | — | — |
| Co-crosslinking agent | | — | — | — | — |
| Antioxidant | | — | — | — | — |
| Process oil | | 63 | 63 | 63 | 63 |
| Vulcanization accelerator (i) | | 1 | 1 | 1 | 1 |
| Vulcanization accelerator (ii) | | 1 | 1 | 1 | 1 |
| Vulcanization accelerator (iii) | | 1 | 1 | 1 | 1 |
| Vulcanization accelerator (iv) | | 1 | 1 | 1 | 1 |
| Vulcanizing agent (sulfur) | | 1 | 1 | 1 | 1 |
| Initial properties | TB (MPa) | 11.3 | 11.4 | 10.9 | 11.0 |
| | EB (%) | 580 | 580 | 540 | 550 |
| Specific gravity | | 1.155 | 1.152 | 1.152 | 1.153 |
| Green strength | 25° C. (MPa) | 0.57 | 0.54 | 0.48 | 0.50 |
| | 60° C. (MPa) | 0.25 | 0.18 | 0.17 | 0.19 |

| | | | | |
|---|---|---|---|---|
| Specific volume resistivity | 3 × 10⁵ | 4 × 10⁵ | 3 × 10⁵ | 6 × 10⁵ |
| (Ω · cm) | | | | |
| Extrusion processability | ◯ | ◯ | ◯ | ◯ |

From the results shown in the above tables, rubber compositions of Examples all had good initial properties (tensile strength, elongation) and a green strength of equal to or greater than the target value. In addition, thickness deviation (wrinkles and bumps) did not occur in the rubber compositions of Examples. Accordingly, the insertion properties of the rubber compositions of Examples into a mandrel are believed to be good.

Example 7 particularly contains both silica and a silane coupling agent. Thus, its specific volume resistivity is high and thus e.g. corrosion of a pipe material can be inhibited or prevented. In addition, because Example 7 has low specific gravity, its weight can be reduced. Further, because Example 7 has high green strength, its wall thickness can be decreased.

Contrarily, in the ethylene-octene resin in the rubber compositions of Comparative Examples, at least one of their melt flow rate (MFR) and their density is out of the predetermined range. Thus, the rubber compositions of Comparative Examples have a green strength of below the target value. Accordingly, because thickness deviation (wrinkles and bumps) easily occurs in rubber compositions of Comparative Examples, it is believed that insertion properties into a mandrel are bad.

In the above Examples, specific modes of the present disclosure were shown. The above Examples are, however, presented for the illustration purpose only. The present disclosure should not be interpreted in any restrictive way. All changes which come within the meaning and range of equivalency of the claims are intended to be embraced therein.

The rubber composition for a water hose of the present disclosure can be used as a rubber composition for a water hose such as a radiator hose, a heater hose and a drain hose.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A rubber composition for a water hose, the rubber composition comprising:
(A) an ethylene-propylene rubber, and
(B) an ethylene-octene resin
wherein the component (B) has a melt flow rate (MFR) of 1.0 g/10 min at a temperature of 190° C. and a load of 2.16 kg, and
wherein the component (B) has a density of 0.870 to 0.908 g/cm³.

2. The rubber composition for a water hose according to claim 1, wherein the content of the component (B) is 8 to 20 parts by weight per 100 parts by weight of the component (A).

3. The rubber composition for a water hose according to claim 1, wherein the rubber composition comprises both silica and a silane coupling agent.

4. The rubber composition for a water hose according to claim 2, wherein the rubber composition comprises both silica and a silane coupling agent.

5. A water hose in a bent shape obtained by forming an unvulcanized hose using the rubber composition for a water hose according to claim 1 and vulcanizing the unvulcanized hose which is inserted into a mandrel in the shape of a bending tube.

6. A water hose in a bent shape obtained by forming an unvulcanized hose using the rubber composition for a water hose according to claim 2 and vulcanizing the unvulcanized hose which is inserted into a mandrel in the shape of a bending tube.

7. A water hose in a bent shape obtained by forming an unvulcanized hose using the rubber composition for a water hose according to claim 3 and vulcanizing the unvulcanized hose which is inserted into a mandrel in the shape of a bending tube.

8. A water hose in a bent shape obtained by forming an unvulcanized hose using the rubber composition for a water hose according to claim 4 and vulcanizing the unvulcanized hose which is inserted into a mandrel in the shape of a bending tube.

9. The water hose according to claim 5, wherein the water hose has a nearly uniform thickness of 3.5 mm or less, and
wherein in a bending part of the water hose, which thickness deviation is not substantially formed.

10. The water hose according to claim 6, wherein the water hose has a nearly uniform thickness of 3.5 mm or less, and
wherein in a bending part of the water hose, which thickness deviation is not substantially formed.

11. The water hose according to claim 7, wherein the water hose has a nearly uniform thickness of 3.5 mm or less, and
wherein in a bending part of the water hose, which thickness deviation is not substantially formed.

12. The water hose according to claim 8, wherein the water hose has a nearly uniform thickness of 3.5 mm or less, and
wherein in a bending part of the water hose, which thickness deviation is not substantially formed.

13. The water hose according to claim 5, wherein the water hose is any one selected from the group consisting of a radiator hose, a heater hose and a drain hose.

14. The water hose according to claim 6, wherein the water hose is any one selected from the group consisting of a radiator hose, a heater hose and a drain hose.

15. The water hose according to claim 7, wherein the water hose is any one selected from the group consisting of a radiator hose, a heater hose and a drain hose.

16. The water hose according to claim 8, wherein the water hose is any one selected from the group consisting of a radiator hose, a heater hose and a drain hose.

17. The water hose according to claim 9, wherein the water hose is any one selected from the group consisting of a radiator hose, a heater hose and a drain hose.

18. The water hose according to claim 10, wherein the water hose is any one selected from the group consisting of a radiator hose, a heater hose and a drain hose.

19. The water hose according to claim 11, wherein the water hose is any one selected from the group consisting of a radiator hose, a heater hose and a drain hose.

20. The water hose according to claim 12, wherein the water hose is any one selected from the group consisting of a radiator hose, a heater hose and a drain hose.
